(19) United States
(12) Patent Application Publication
(10) Pub. No.: US 2026/0086933 A1
(43) Pub. Date: Mar. 26, 2026

(54) CHIP AND ITS MEMORY MANAGEMENT METHOD

(71) Applicant: Sigmastar Technology Ltd., Xiamen (CN)

(72) Inventors: Xuelin Ye, Shenzhen (CN); Wenshuai Xi, Shenzhen (CN)

(21) Appl. No.: 19/314,024

(22) Filed: Aug. 29, 2025

(30) Foreign Application Priority Data
Sep. 24, 2024 (CN) 202411337539.6

(51) Int. Cl. G06F 12/02

(52) U.S. Cl. CPC G06F 12/023; G06F 2212/1016

(57) ABSTRACT

A chip is connected to a memory that includes a memory section composed of multiple memory blocks. The chip includes a memory management circuit and a computing circuit. The computing circuit, connected to both the memory and the memory management circuit, is configured to execute a memory management driver to perform the following steps: receiving a memory request; searching a memory region for at least one free memory block according to a memory region linked list containing a node corresponding to the memory region, where the memory region is a part of the memory section; and using the memory management circuit to perform memory mapping on the at least one free memory block found.

This application claims the benefit of China application Serial No. 202411337539.6, filed on May 24, 2024, the subject matter of which is incorporated herein by reference.

### BACKGROUND OF THE INVENTION

### 1. Field of the Invention

The present invention generally relates to memories, and more particularly, to the management of memories.

### 2. Description of Related Art

The contiguous memory allocator (CMA) and the memory management unit (MMU) are two common methods of memory allocation and/or management in the Linux system. The contiguous memory allocator is suitable for allocating continuous and large blocks of memory, but its disadvantage is that it easily causes memory fragmentation.

The MMU provides the mapping between the virtual memory address and the physical memory address. However, the memory reserved for the MMU can only be used by the device, but cannot be used by the system's application, greatly reducing the flexibility of memory usage.

Therefore, there is a need for a better memory management method.

### SUMMARY OF THE INVENTION

In view of the issues of the prior art, an object of the present invention is to provide a chip and a memory management method of the chip, so as to make an improvement to the prior art.

According to one aspect of the present invention, a chip is provided. The chip is coupled to a memory. The memory includes a memory section. The memory section contains a plurality of memory blocks. The chip includes a memory management circuit and a computing circuit. The computing circuit is coupled to the memory and the memory management circuit and is configured to execute a memory management driver to perform the following steps: receiving a memory request; searching a memory region for at least one free memory block according to a memory region linked list, wherein the memory region linked list contains a node corresponding to the memory region, and the memory region is a part of the memory section; and using the memory management circuit to perform memory mapping on the at least one free memory block that is found.

According to another aspect of the present invention, a memory management method is provided. The memory management method is applied to a memory. The memory includes a memory section. The memory section includes a plurality of memory blocks. The method includes the following steps: receiving a memory request; searching a memory region for at least one free memory block according to a memory region linked list, wherein the memory region linked list contains a node corresponding to the memory region, and the memory region is a part of the memory section; and using a memory management circuit to perform memory mapping on the at least one free memory block that is found.

The technical means embodied in the embodiments of the present invention can solve at least one of the problems of the prior art. Therefore, compared to the prior art, the present invention can use memory more effectively.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is the functional block diagram of an electronic device according to an embodiment of the present invention.

FIG. 2A is the schematic diagram of a memory section according to the present invention.

FIG. 2B is the schematic diagram of a memory block structure array and a memory region linked list according to an embodiment of the present invention.

FIG. 3 is the flowchart of a memory management method according to an embodiment of the present invention.

FIG. 4 is the flowchart of step S340 in FIG. 3 according to an embodiment.

FIG. 5 is the flowchart of step S360 in FIG. 3 according to an embodiment.

FIG. 6 is the flowchart for releasing memory according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a chip and its memory management method. On account of that some or all elements of the chip could be known, the detail of such elements is omitted provided that such detail has little to do with the features of this disclosure, and that this omission nowhere dissatisfies the specification and enablement requirements. Some or all of the processes of the memory management method may be implemented by software and/or firmware and can be performed by the chip or its equivalent. A person having ordinary skill in the art can choose components or steps equivalent to those described in this specification to carry out the present invention, which means that the scope of this invention is not limited to the embodiments in the specification.

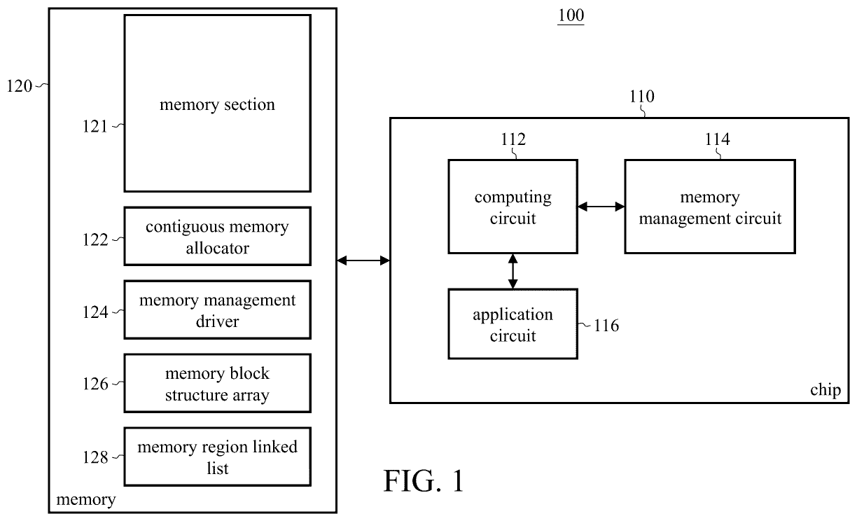

Reference is made to FIG. 1, which is a functional block diagram of an electronic device according to an embodiment of the present invention. The electronic device 100 includes a chip 110 and a memory 120.

The chip 110 includes a computing circuit 112, a memory management circuit 114, and an application circuit 116. The computing circuit 112 may be a circuit or electronic component with program execution capability, such as a central processing unit (CPU), a microprocessor, a microcontroller unit, a digital signal processor (DSP), an application-specific integrated circuit (ASIC), or an equivalent circuit. The computing circuit 112 carries out some of the functions of the electronic device 100 by executing the program code and/or program instructions stored in the memory 120, such as executing the memory management program instructions to perform allocation management on the memory 120. In some embodiments, the memory management circuit 114 can be embodied by a conventional MMU. The application circuit 116 is responsible for some of the functions of the electronic device 100.

The memory 120 contains the reserved memory section 121, and stores the contiguous memory allocator 122, the memory management driver 124, the memory block structure array 126, and the memory region linked list 128. The memory section 121 is a physically contiguous memory section. The contiguous memory allocator 122 and the memory management driver 124 are stored in the memory 120 in the form of code or program instructions and are executed by the computing circuit 112.

The contiguous memory allocator 122, which may be a part of the operating system of the electronic device 100 (e.g., Linux), is used to perform conventional memory allocation.

The memory management driver 124 serves as a bridge between the computing circuit 112 and the contiguous memory allocator 122. The memory management driver 124 manages the use or allocation of the internal memory blocks MB in the memory section 121 according to the memory requests issued by the computing circuit 112, and issues memory allocation requests to the contiguous memory allocator 122 when necessary.

The memory block structure array 126 records multiple memory block structures MBS in the form of an array or a linked list. These memory block structures MBS correspond to all memory blocks MB in the memory section 121. For example, if the size of the memory section 121 is 256 MB (Megabyte), and the size of a memory block MB is 128 KB (Kilobyte), then the memory section 121 contains 2000 (=256 MB/128 KB) memory blocks MB, and the memory block structure array 126 contains 2000 memory block structures MBS.

The memory region linked list 128 records, in the form of a linked list, at least one memory region allocated by the contiguous memory allocator 122 in the memory section 121.

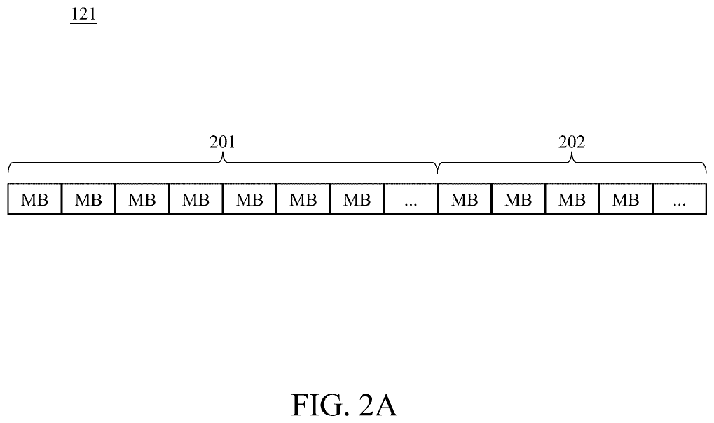

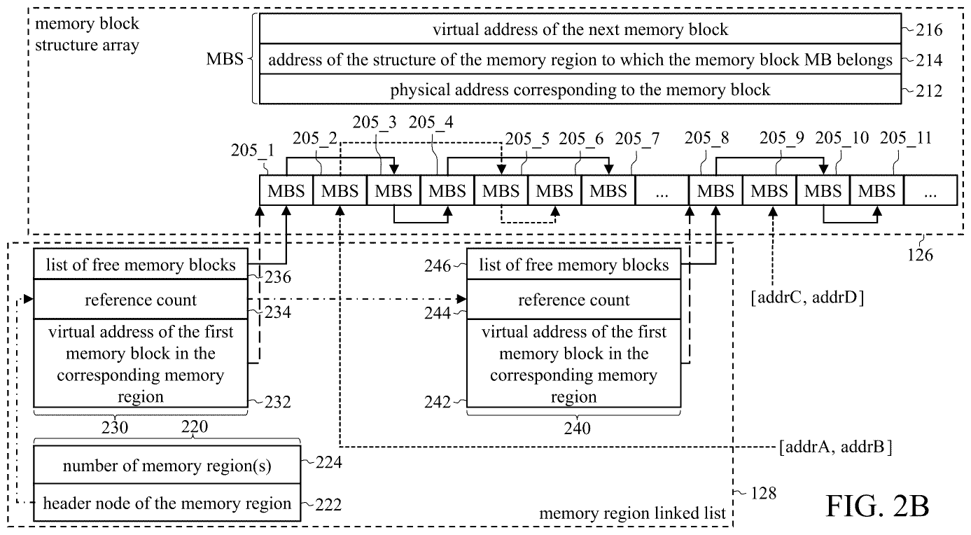

Reference is made to FIG. 2A, which is a schematic diagram of the memory section 121 according to the present invention. The memory section 121 includes at least one memory region, and each memory region contains multiple memory blocks MB. In the example of FIG. 2A, the memory section 121 includes the memory region 201 and the memory region 202, and the memory region 201 and the memory region 202 each include multiple memory blocks MB.

Reference is made to FIG. 2B, which is a schematic diagram of a memory block structure array and a memory region linked list according to an embodiment of the present invention.

The memory block structure array 126 contains multiple memory block structures MBS. Each memory block structure MBS corresponds to a memory block MB and includes the physical address 212 corresponding to the memory block, the address 214 of the structure of the memory region to which the memory block MB belongs, and the virtual address 216 of the next memory block. Based on the configuration file pre-generated by the computing circuit 112 (which can be stored in the memory 120, though not shown in the figure), the contiguous memory allocator 122 can find a contiguous memory space in the memory 120 (i.e., the memory section 121) and create a memory block structure array 126 that corresponds to or describes the memory space. The configuration file includes but is not limited to the size of the memory block MB and the minimum allocation size. The allocation of the memory section 121 and the creation of the memory block structure array 126 can be executed when the electronic device 100 starts up.

The memory region linked list 128 includes the start 220, the node 230, and the node 240. Each node in the memory region linked list 128 corresponds to a memory region. For example, the node 230 and the node 240 can correspond to the memory region 201 and the memory region 202, respectively. The node 230 (240) contains the virtual address 232 (242) of the first memory block in the corresponding memory region, a reference count 234 (244), and a list 236 (246) of free memory blocks.

In the embodiment of FIG. 2B, the node 230 is the header node of the memory region linked list 128, and the node 240 is connected to the node 230. The implementation of the linked list is well known to people having ordinary skill in the art, so further elaboration is omitted for brevity. The start 220 includes the header node 222 of the memory region(s) and the number 224 of memory region(s). The header node 222 of the memory region points to the node 230. Because each node corresponds to a memory region, in the embodiment of FIG. 2B, the number 224 of memory region(s) is equal to 2 (i.e., the node 230 and the node 240).

For example, in the embodiment of FIG. 2B, the memory region corresponding to the node 230 includes at least the seven memory blocks MB corresponding to the memory block structures 205_1, 205_2, 205_3, 205_4, 205_5, 205_6, and 205_7, and the memory region corresponding to the node 240 includes at least the four memory blocks MB corresponding to the memory block structures 205_8, 205_9, 205_10, and 205_11.

The virtual address 232 of the first memory block in the memory region corresponding to the node 230 points to the virtual address of the memory block structure 205_1. The virtual address 242 of the first memory block in the memory region corresponding to the node 240 points to the virtual address of the memory block structure 205_8. The reference count 234 and the reference count 244 record the number of allocated memory blocks MB within their respective memory regions. The lists 236 and 246 of free memory blocks point to the free memory block(s) MB within the memory region. A memory block MB in any memory region has only two states: allocated or free.

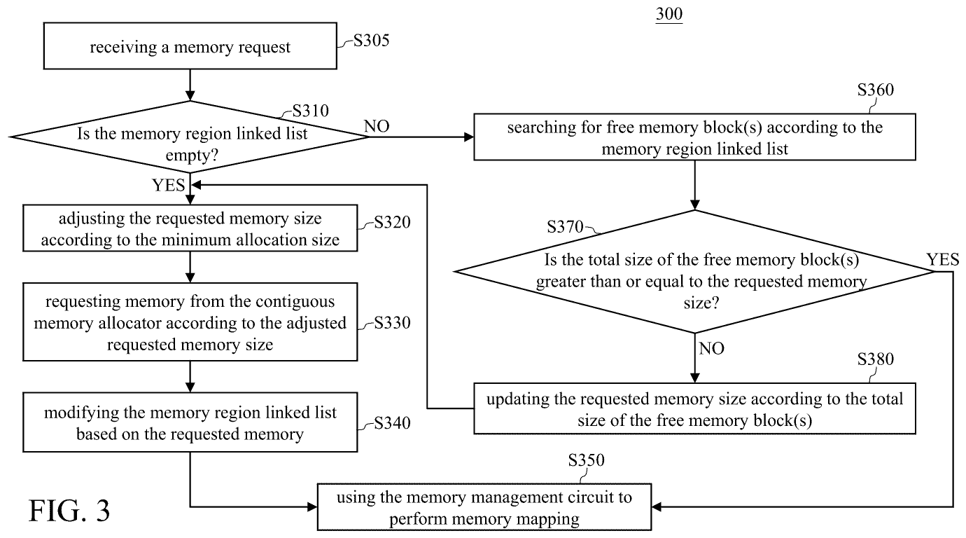

Reference is made to FIG. 3, which is a flowchart of the memory management method according to an embodiment of the present invention. In the following discussion, it is assumed that the size of the memory section 121 is 256 MB, the size of each memory block MB is 128 KB, and the minimum allocation size is 16 MB. The memory management method 300 is executed by the computing circuit 112 and includes the following steps.

Step S305: Receiving a memory request from an application or a device (e.g., the application circuit 116). In the following discussion, it is assumed that the requested memory size is 20 MB.

Step S310: Determining whether the memory region linked list 128 is empty, which means determining whether the number 224 of memory region(s) is 0 (equivalent to determining whether the number of nodes in the memory region linked list 128 is 0). If YES, then the flow proceeds to step S320; otherwise, the flow proceeds to step S360.

Step S320: Adjusting the requested memory size according to the minimum allocation size. This step is the alignment, which is used to prevent memory fragmentation within the memory section 121. If the size of the memory section 121 is X (where X is an integer), then the minimum allocation size is a factor of X, and the adjusted requested memory size is an integer multiple of the minimum allocation size. For example, because the requested memory size is 20 MB, and the minimum allocation size is 16 MB (16 is a factor of 256), the adjusted requested memory size is ┌20/16┐×16=32 MB.

Step S330: Requesting memory from the contiguous memory allocator 122 according to the adjusted requested memory size. Continuing from the previous example, since the adjusted requested memory size is 32 MB, the memory management driver 124 requests the contiguous memory allocator 122 for 32 MB of memory. Due to the size of a memory block MB being 128 KB, the contiguous memory allocator 122 will allocate a memory region containing 250 (=32 MB/128 KB) memory blocks MB within the memory section 121. Then, the computing circuit 112 can obtain the physical addresses of these 250 memory blocks MB according to the memory block structure array 126.

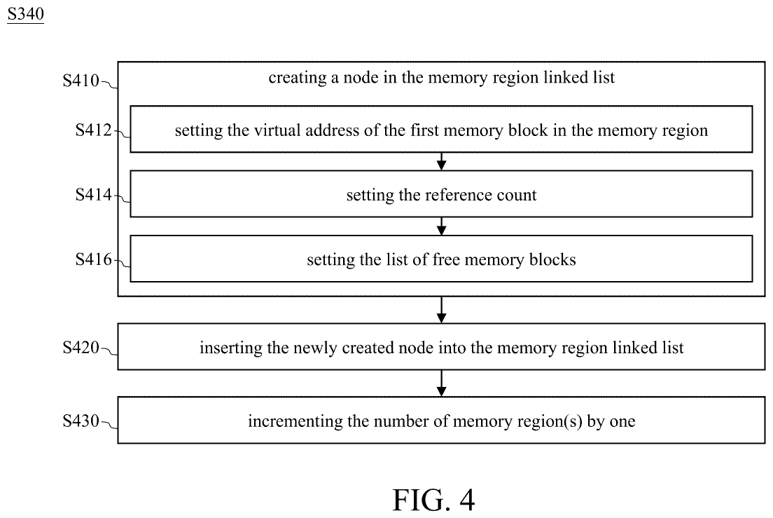

Step S340: Modifying the memory region linked list 128 based on the requested memory. Reference is made to FIG. 4, which is a flowchart of step S340 according to an embodiment. The flow contains the following steps.

Step S410: Creating a node in the memory region linked list 128. For example, suppose the memory region linked list 128 originally has no nodes (i.e., the memory management driver 124 has never requested memory from the contiguous memory allocator 122), then the computing circuit 112 (more specifically, the memory management driver 124) creates the node 230 in this step.

In some embodiments, Step S410 includes the following sub-steps.

Step S412: Setting the virtual address 232 of the first memory block in the memory region. Reference is made to FIG. 2B. Assuming that the memory region corresponding to the node 230 contains the memory blocks MB corresponding to the first 250 memory block structures MBS of the memory block structure array 126, the memory management driver 124 points the virtual address 232 of the first memory block in the memory region to the virtual address of the memory block structure 205_1.

Step S414: Setting the reference count 234. Due to the fact that actually only 160 (=20 MB/128 KB) of the 250 memory blocks MB will be used (the remaining 90 (=12 MB/128 KB) are allocated for alignment purposes), the reference count 234 is set to 160.

Step S416: Setting the list 236 of free memory blocks. Reference is made to FIG. 2B. Assuming that the start of the free memory block(s) MB is the memory block MB corresponding to the memory block structure 205_1, the memory management driver 124 points the list 236 of free memory blocks to the virtual address of the memory block structure 205_1. Continuing from the previous example, the memory management driver 124 inserts the memory block structure MBS corresponding to the free 12 (=32-20) MB of memory blocks into the list 236 of free memory blocks, so that the list 236 of free memory blocks contains 90 (=12 MB/128 KB) memory block structures MBS. Each memory block structure MBS is a node of the list 236 of free memory blocks.

Step S420: Inserting the newly created node (i.e., the node 230 created in the previous step) into the memory region linked list 128. More specifically, if the newly created node is the first node of the memory region linked list 128, then the header node 222 of the memory region is pointed to the newly created node; otherwise, the newly created node is inserted at the end of the memory region linked list 128.

Step S430: Incrementing the number 224 of memory region(s) of the start 220 by one.

Return to FIG. 3.

Step S350: Using the memory management circuit 114 to perform memory mapping. More specifically, the computing circuit 112 provides the physical address(es) and virtual address(es) of the allocated memory block(s) MB to the memory management circuit 114 for memory mapping. Continuing from the previous example, the memory management driver 124 inserts the memory block structures MBS corresponding to the requested memory (20 MB) from the memory block structure array 126 into the mapping address record linked list of the memory management circuit 114 for mapping, that is, writing the mapping relationship between the physical address and the virtual address of each allocated memory block MB into the mapping address record linked list of the memory management circuit 114. After mapping, the physical address and the virtual address of the first memory block structure MBS of the memory block structures MBS are saved to the mapping address record linked list of the memory management circuit 114.

For example (referring to FIG. 2B), after mapping, the memory management circuit 114 records the virtual address addrA and the virtual address addrB. The address range between the two virtual addresses corresponds to the allocated memory blocks MB of the memory region 201 (i.e., the memory region corresponding to the node 230) (i.e., the aforementioned 160 (=20 MB/128 KB) memory blocks MB, for example, corresponding to the memory block structures 205_2, 205_5, 205_6, ...).

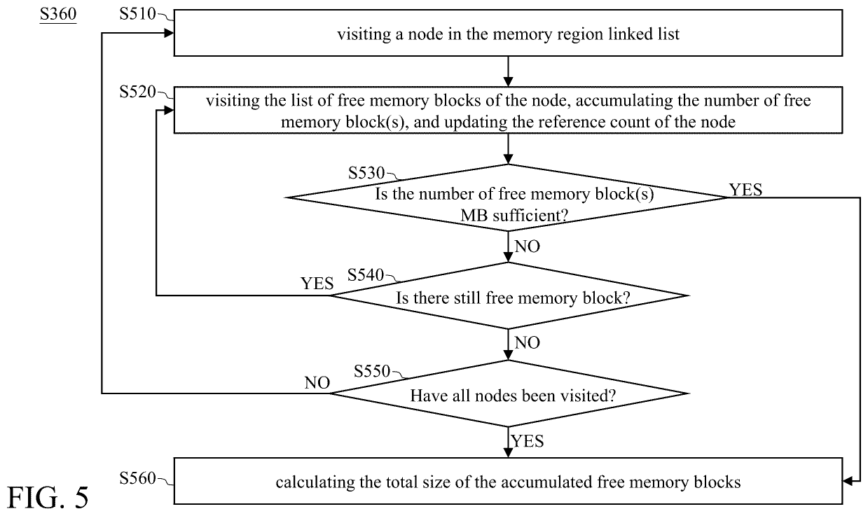

Step S360: Searching for free memory block(s) MB according to the memory region linked list 128. When the memory region linked list 128 is not empty (e.g., in the previous example where the node 230 has been created), it indicates at least one allocated memory region (e.g., the memory region 201) is existed, and the at least one allocated memory region may contain free memory block(s) MB (e.g., the memory block(s) MB pointed to by the list 236 of free memory blocks). This step is to use the free memory block(s) MB in the allocated memory region in order to utilize the memory section 121 more efficiently. The details of this step will be discussed below with reference to FIG. 5.

Step S370: Determining whether the total size of the free memory block(s) is greater than or equal to the requested memory size. If YES, then the flow proceeds to step S350 to perform memory mapping using the free memory block(s) MB obtained from step S360; otherwise, the flow proceeds to step S380.

Step S380: Updating the requested memory size according to the total size of the free memory block(s). Continuing from the previous example, the total size of the free memory block(s) MB is 12 MB. If the requested memory size in this case is 18 MB, then the memory management driver 124 updates the requested memory size to 18-12=6 MB. Next, in step S320, the memory management driver 124 adjusts the requested memory size to ┌6/16┐×16=16 MB. Note that, in the subsequent step S350, the memory management driver 124 will provide the free memory block(s) MB obtained from step S360, as well as the memory region allocated from step S340 (more specifically, taking 6 MB from it), to the memory management circuit 114 for mapping.

As discussed above, it can be seen that the memory management driver 124 prioritize using the free memory block(s) MB in the existing memory region to improve the utilization efficiency of the memory section 121 and avoid waste.

In some embodiments, after the memory management circuit 114 completes the mapping (i.e., after step S350), the computing circuit 112 provides the mapped virtual address to the application or the application circuit 116 for use. In other words, in the present invention, the application and the device can both use the memory section 121. For example, the chip 110 may be an image processing chip, and the application circuit 116 may be an image decoding circuit.

Reference is made to FIG. 5, which is a flowchart of step S360 according to an embodiment. FIG. 5 includes the following steps.

Step S510: Visiting a node in the memory region linked list 128. Continuing from the previous example, suppose at this time the memory region linked list 128 only has the node 230, then the memory management driver 124 visits the node 230.

Step S520: Visiting the list 236 of free memory blocks of the node, accumulating the number of free memory block(s), and updating the reference count of the node.

Step S530: Determining whether the number of free memory block(s) MB is sufficient. If YES, the flow proceeds to step S560; otherwise, the flow proceeds to step S540.

Step S540: Determining whether there is still free memory block MB in the node. If YES, the flow proceeds to the step S520; otherwise, the flow proceeds to step S550.

In other words, in the steps S520 to S540, the memory management driver 124 continuously searches for free memory block(s) MB in a certain node (i.e., in the memory region corresponding to the node) until the number of free memory block(s) MB is sufficient (step S530 is YES), or there is no free memory block MB in the node (step S540 is NO). In this process, the memory management driver 124, upon finding each free memory block MB, increments the count of free memory blocks and increases the reference count of the node by one (step S520), indicating that the state of the memory block MB has changed from free to allocated.

Step S550: Determining whether all nodes have been visited. If YES, the flow proceeds to step S560; otherwise, the flow proceeds to step S510.

Step S560: Calculating the total size of the accumulated free memory blocks. For example, if the number of accumulated free memory blocks MB is P, and the size of each memory block MB is Q, then the total size is P*Q.

Continuing from the previous example, because the requested memory size is 18 MB, and the total size of the free memory block(s) MB of the node 230 is 12 MB, the result of step S530 and step S540 is NO. Next, because at this time the memory region linked list 128 only has the node 230, the result of step S550 is YES. Then, the result of step S370 in FIG. 3 is NO, and the memory management driver 124 performs steps S380, S320, S330, S340, and S350 to create the node 240 (i.e., to request the memory region 202 from the contiguous memory allocator 122). Reference is made to FIG. 2B, where it is assumed that the memory management circuit 114 records the virtual address addrC and the virtual address addrD. The address range between the two virtual addresses corresponds to the allocated memory blocks MB in the memory region 202.

In another example, suppose the requested memory size is 10 MB. Because the total size of the free memory block(s) MB at the node 230 (12 MB) is greater than the requested memory size (10 MB), the result of step S530 is YES, and the result of the next step S370 is also YES. That is to say, in this example, the memory management driver 124 does not need to request memory from the contiguous memory allocator 122, and thus the node 240 will not be created. After the memory management method 300 is completed, there are still free memory blocks MB (a total of 12-10=2 MB) in the node 230.

Note that when the result of step S370 is YES, because the memory management driver 124 does not need to request memory from the contiguous memory allocator 122, the memory management driver 124 does not adjust the requested memory size to an integer multiple of the minimum allocation size (i.e., step S320 is not performed). In other words, in the present invention, although the memory management method 300 implements the alignment mechanism, a memory request does not trigger the alignment operation (i.e., step S320 is not performed) even if the requested memory size is not an integer multiple of the minimum allocation size (e.g., 10 MB is not an integer multiple of 16 MB in the aforementioned example).

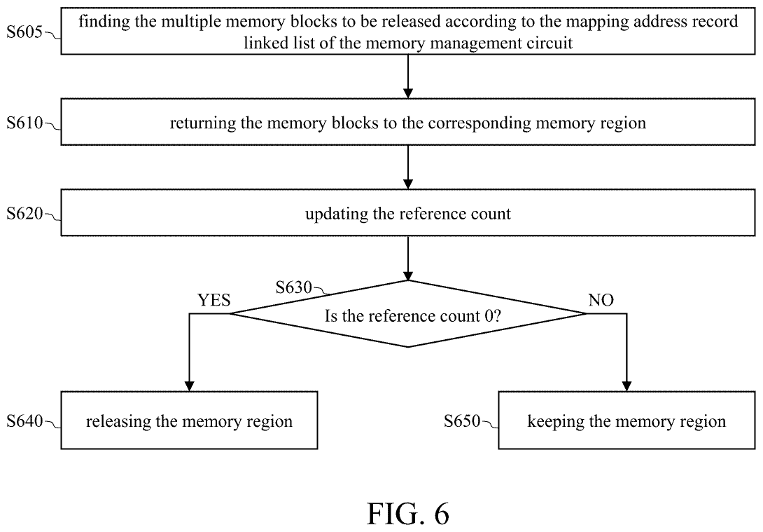

Reference is made to FIG. 6, which is a flowchart for releasing memory according to an embodiment of the present invention. The process of FIG. 6 is performed by the computing circuit 112 and includes the following steps.

Step S605: Finding the multiple memory blocks MB to be released according to the mapping address record linked list of the memory management circuit 114. For example (referring to FIG. 2B), the memory block structure 205_2 can be found according to the virtual address addrA, and then all of the memory blocks MB between the virtual address addrA and the virtual address addrB can be found according to the memory block structure array 126 (where the memory blocks MB are allocated memory blocks MB).

Step S610: Returning the memory blocks MB to the corresponding memory region (i.e., releasing the memory blocks MB). Reference is made to FIG. 2B. Because each memory block structure MBS records the address 214 of the structure of the memory region to which the memory block MB belongs, the memory management driver 124 can find the memory region to which any memory block MB belongs according to the address 214 of the structure of the memory region to which the memory block MB belongs. The details of this step are to insert the memory block structures MBS of the memory blocks MB into the list of free memory blocks in the corresponding memory region.

Step S620: Updating the reference count. Assuming that in the previous step, R memory block(s) MB were released (i.e., R memory block structure(s) MBS were inserted into the list of free memory blocks), this step subtracts R from the reference count.

Step S630: Determining whether the reference count is 0. If YES (meaning that all of the memory blocks MB in the memory region are free, that is, all have been released), then the flow proceeds to step S640; otherwise, keeping that memory region (i.e., keeping the corresponding node) (step S650).

Step S640: Releasing the memory region, that is, deleting the node from the memory region linked list 128.

The Linux operating system is intended to illustrate the invention by way of example and not to limit the scope of the claimed invention. People having ordinary skill in the art may apply the present invention to other types of operating systems in accordance with the foregoing discussions.

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A chip coupled to a memory, the memory comprising a memory section, the memory section comprising a plurality of memory blocks, the chip comprising:
a memory management circuit; and
a computing circuit coupled to the memory and the memory management circuit, and configured to execute a memory management driver to perform following steps:
receiving a memory request;
searching a memory region for at least one free memory block according to a memory region linked list, wherein the memory region linked list contains a node corresponding to the memory region, and the memory region is a part of the memory section; and
performing memory mapping on the at least one free memory block found via the memory management circuit.

2. The chip of claim 1, wherein the node is a first node, the memory region is a first memory region, and the computing circuit further performs following steps:
creating a second node in the memory region linked list when a total size of the at least one free memory block found is smaller than a requested memory size of the memory request, wherein the second node corresponds to a second memory region, and the second memory region is a part of the memory section and comprises a plurality of memory blocks and an allocated memory block; and
performing mapping on the allocated memory block via the memory management circuit.

3. The chip of claim 2, wherein the total size is a first total size, and a sum of the first total size and a second total size of the allocated memory block is equal to the requested memory size.

4. The chip of claim 2, wherein the first memory region and the second memory region are allocated by a contiguous memory allocator.

5. The chip of claim 1, wherein the node comprises a list of free memory blocks, and the list of free memory blocks points to the at least one free memory block found.

6. The chip of claim 5, wherein the step of searching the memory region for the at least one free memory block according to the memory region linked list includes visiting the list of free memory blocks.

7. The chip of claim 5, wherein the memory region comprises a plurality of allocated memory blocks, and the computing circuit further performs following steps:
inserting a plurality of memory block structures corresponding to the plurality of allocated memory blocks into the list of free memory blocks to release the plurality of allocated memory blocks.

8. The chip of claim 7, wherein the computing circuit further performs following steps:
removing the node from the memory region linked list when all of the plurality of allocated memory blocks of the node have been released.

9. The chip of claim 8, wherein the node comprises a reference count, and the computing circuit further performs following steps:
determining whether all of the plurality of allocated memory blocks of the node have been released according to the reference count.

10. The chip of claim 1, wherein the memory region is an integer multiple of a minimum allocation size, and when a total size of the at least one free memory block found is greater than or equal to a requested memory size of the memory request, the requested memory size is not adjusted to an integer multiple of the minimum allocation size.

11. A memory management method applied to a memory, the memory comprising a memory section, the memory section comprising a plurality of memory blocks, the method comprising:
receiving a memory request;
searching a memory region for at least one free memory block according to a memory region linked list, wherein the memory region linked list contains a node corresponding to the memory region, and the memory region is a part of the memory section; and
performing memory mapping on the at least one free memory block found via the memory management circuit.

12. The method of claim 11, wherein the node is a first node, the memory region is a first memory region, and the method further comprises:
creating a second node in the memory region linked list when a total size of the at least one free memory block found is smaller than a requested memory size of the memory request, wherein the second node corresponds to a second memory region, and the second memory region is a part of the memory section and comprises a plurality of memory blocks and an allocated memory block; and
performing mapping on the allocated memory block via the memory management circuit.

13. The method of claim 12, wherein the total size is a first total size, and a sum of the first total size and a second total size of the allocated memory block is equal to the requested memory size.

14. The method of claim 11, wherein the node contains a list of free memory blocks, the list of free memory blocks points to the at least one free memory block found, and the step of searching the memory region for the at least one free memory block according to the memory region linked list visits the list of free memory blocks.

15. The method of claim 14, wherein the memory region comprises a plurality of allocated memory blocks, and the method further comprises:
inserting a plurality of memory block structures corresponding to the plurality of allocated memory blocks into the list of free memory blocks to release the plurality of allocated memory blocks.

16. The method of claim 15 further comprising:
removing the node from the memory region linked list when all of the plurality of allocated memory blocks of the node have been released.

17. The method of claim 16, wherein the node comprises a reference count, and the method further comprises:
determining whether all of the plurality of allocated memory blocks of the node have been released according to the reference count.

18. The method of claim 11, wherein the memory region is an integer multiple of a minimum allocation size, and when a total size of the at least one free memory block found is greater than or equal to a requested memory size of the memory request, the requested memory size is not adjusted to an integer multiple of the minimum allocation size.
